(19) United States
(12) Patent Application Publication
(10) Pub. No.: US 2003/0078857 A1
(43) Pub. Date: Apr. 24, 2003

(54) Method and system for realizing electronic commerce by use of POS system

(75) Inventor: Yasunori Ookushi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/259,856

(22) Filed: Sep. 30, 2002

(30) Foreign Application Priority Data
Sep. 28, 2001 (JP) 2001-299754

(51) Int. Cl. G06F 17/60

(52) U.S. Cl. 705/26

(57) ABSTRACT

A method and a system for realizing an electronic commerce is provided. Registrations are made as sale registration data of not only at least one real-goods displayed in a real-shop and ordered by a purchaser but also at least one online-goods displayed in at least one virtual-shop and ordered by the purchaser, before accomplishing a batch accounting operation for the at least one real-goods and the at least one online-goods registered on the sale registration data.

### BACKGROUND OF THE INVENTION

1. Field of the Invention

The present invention relates to a method and a system for realizing an electronic commerce, and more particularly to a method and a system for realizing an electronic commerce with an efficient accounting operation for purchasing one or more real goods and/or items displayed in a real shop and also purchasing one or more virtual goods and/or items displayed in a virtual shop such as online shop via a single terminal device installed in the same real shop.

All of patents, patent applications, patent publications, scientific articles and the like, which will hereinafter be cited or identified in the present application, will, hereby, be incorporated by references in their entirety in order to describe more fully the state of the art, to which the present invention pertains.

2. Description of the Related Art

In accordance with the past practices in electronic commerce, peoples might purchase one or more real goods and/or items displayed in a real shop and also purchase one or more virtual goods and/or virtual items displayed in a virtual shop such as online shop via an terminal device installed in the same real shop. FIG. 1 is a schematic view of a conventional system for realizing an electronic commerce with an inefficient and inconvenient accounting operation for purchasing one or more real goods and/or items displayed in a real shop and also purchasing one or more virtual goods and/or items displayed in a virtual shop such as online shop via a single terminal device installed in the same real shop. In one typical example, this real shop may install a point-of-sale terminal (POS-terminal) 11 and an online-shop dedicated terminal 12. The point-of-sale terminal (POS-terminal) 11 is provided for accounting operation in purchasing the real goods and/or the real items displayed in this real shop. The online-shop dedicated terminal 12 is used for access to the virtual shop such as online shop and for browsing and purchasing the virtual goods and/or items displayed in the virtual shop, and taking subsequent accounting operation.

Even in one real shop, purchaser have to use both the point-of-sale terminal (POS-terminal) 11 and the online-shop dedicated terminal 12 for purchases one or more real goods and/or items and further one or more virtual goods and/or items. This means that inconvenient separate two accounting operations through the point-of-sale terminal (POS-terminal) 11 and through the online-shop dedicated terminal 12 are necessary. The above prior art is time-consuming and inconvenient.

Further, no efficient management system or method was available to the shop side.

In the above circumstances, the development of a novel method and system for realizing an electronic commerce free from the above problems is desirable.

### SUMMARY OF THE INVENTION

Accordingly, it is an object of the present invention to provide a novel method for realizing an electronic commerce free from the above problems.

It is a further object of the present invention to provide a novel method for realizing an electronic commerce with an efficient accounting operation for purchasing one or more real goods and/or items displayed in a real shop and also purchasing one or more virtual goods and/or items displayed in a virtual shop such as online shop via a single terminal device installed in the same real shop.

It is a still further object of the present invention to provide a novel system for realizing an electronic commerce free from the above problems.

It is yet a further object of the present invention to provide a novel system for realizing an electronic commerce with an efficient accounting operation for purchasing one or more real goods and/or items displayed in a real shop and also purchasing one or more virtual goods and/or items displayed in a virtual shop such as online shop via a single terminal device installed in the same real shop.

In one aspect of the invention, there is provided a method of realizing an electronic commerce, which includes a step of making registrations as sale registration data of not only at least one real-goods displayed in at least one virtual-shop and ordered by the purchaser. The method also includes a step of accomplishing a batch accounting operation for the at least one real-goods and the at least one online-goods registered on the sale registration data.

In other aspect of the invention, there is provided a method of realizing an electronic commerce, which includes a step of making registrations as sale registration data of not only at least one real-goods displayed in a real-shop and ordered by a purchaser but also at least one online-goods displayed in at least one virtual-shop and ordered by the purchaser by user of a POS-terminal device installed in the real-shop. The method also includes a step of accomplishing a batch accounting operation for the at least one real-goods and the at least one online-goods registered on the sale registration data by use of the POS-terminal device.

In another aspect of the invention, there is provided a system for realizing an electronic commerce. The system includes at least one virtual-shop which deals with at least one online-goods. The system also includes a POS-terminal device installed in at least one real-shop which deals with at least one online-goods, and the POS-terminal device being accessible to the at least one real-ship. The POS-terminal device makes registrations as sale registration data of not only at least one real-goods displayed in the real-shop and ordered by a purchaser but also at least one online-goods displayed in at least one virtual-shop and ordered by the purchaser by use of a POS-terminal device installed in the real-shop. The POS-terminal device accomplished a batch accounting operation for the at least one real-goods and the at least one online-goods registered on the sale registration data by use of the POS-terminal device.

In yet another aspect of the invention, there is provided a computer program to be executed for realizing an electronic commerce, which includes making registrations as sale registration data of not only at least one real-goods displayed in a real-shop and ordered by a purchaser but also at least one online-goods displayed in the at least one virtual-shop and ordered by the purchaser by use of a POS-terminal device installed in the real-shop. The computer program also includes accomplishing a batch accounting operation for the at least one real-goods and the at least one online-goods registered on the sale registration data by use of the POS-terminal device.

### BRIEF DESCRIPTION OF THE DRAWINGS

Preferred embodiments according to the present invention will be described in detail with reference to the accompanying drawings.

FIG. 1 is a schematic view of a conventional system for realizing an electronic commerce with an inefficient and inconvenient accounting operation for purchasing one or more real goods and/or items displayed in a real shop and also purchasing one or more virtual goods and/or items displayed in a virtual shop such as online shop via a single terminal device installed in the same real shop.

FIG. 2 is a schematic view of a novel system for realizing an electronic commerce with an efficient and convenient accounting operation for purchasing one or more real goods and/or items displayed in a real shop and also purchasing one or more virtual goods and/or items displayed in a virtual shop such as online shop via a single terminal device installed in the same real shop in a first embodiment in accordance with the present invention.

FIG. 3 is a flow chart of sequential operations of the electronic commerce system of FIG. 2.

FIG. 4A is a schematic perspective view of a point-of-sale terminal (POS-terminal) which displays informations of the online-goods on the customer display in FIG. 2.

FIG. 4B is a schematic view of the list of the online-goods with bar-codes.

FIG. 5 is a view illustrative of one typical example of data structure of the POS-sales registration data.

FIG. 6 is a flow chart of sequential operations of the electronic commerce system in the second embodiment in accordance with the present invention.

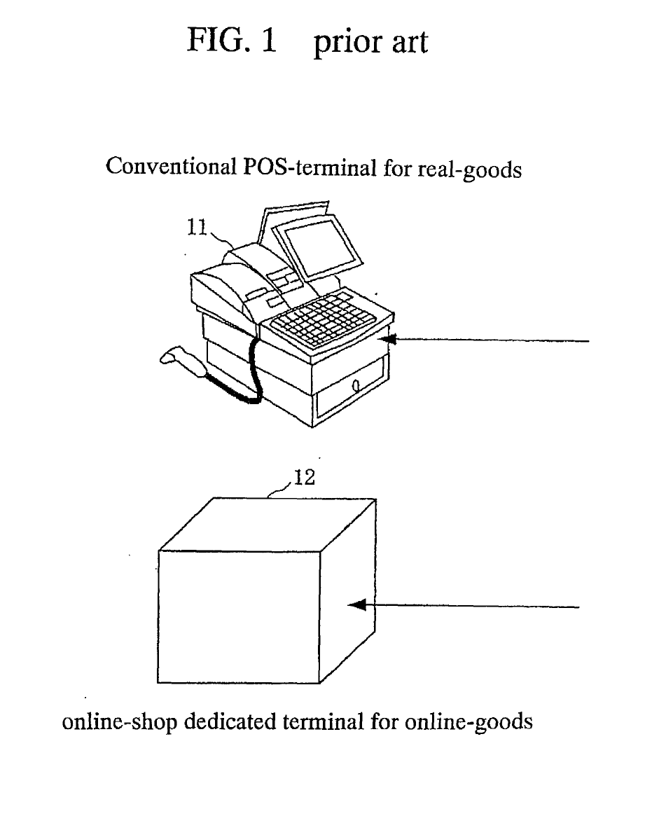

### DETAILED DESCRIPTION OF THE PREFERRED EMBODIMENTS

A first aspect of the present invention is a method of realizing an electronic commerce. The method includes the steps of: making registrations as sale registration data of not only at least one real-goods displayed in a real-shop and ordered by a purchaser but also at least one online-goods displayed in at least one virtual-shop and ordered by the purchaser; and accomplishing a batch accounting operation for the at least one real-goods and the at least one online-goods registered on the sale registration data.

It is preferable to further include the step of: displaying online-goods-related informations for allowing the purchaser to view the online-goods-related informations and to select the at least one online-goods from the online-goods-related informations. In one example, the online-goods-related informations may be displayed on a customer display device in the real shop for allowing the purchaser to review the customer display device. In another example, the online-goods-related informations may be displayed on a printed paper in the real shop for allowing the purchaser to review the printed paper. In still another example, the online-goods-related informations may be displayed on a printed leaflet in the real shop for allowing the purchaser to review the printed leaflet. In typical example, the online-goods-related informations are image data of the at least one online-goods.

In one typical example, the step of making registrations as sale registration data may include registrations as sale registration data of both image data of the at least one online-goods and an uniform resource locator of the at least one virtual-shop which deals with the at least one online-goods.

In one preferable example, it may be possible to print out an order-printed sheet which presents the at least one online-goods ordered by the purchaser, wherein the order-printed sheet also serves as an ordered-goods-verification for verifying the at least one online-goods was ordered by the purchaser.

In typical example, the step of making registrations as sale registration data and the step of accomplishing the batch accounting operation may be realized by use of a terminal device installed in a real shop. In this case, the terminal device may make an access to the at least one virtual-shop which deals with the at least one online-goods for representing the purchaser in purchasing the at least one online-goods from the at least one virtual-shop.

A second aspect of the present invention is a method of realizing an electronic commerce. The method includes the steps of: making registrations as sale registration data of not only at least one real-goods displayed in a real-shop and ordered by a purchaser but also at least one online-goods displayed in at least one virtual-shop and ordered by the purchaser by use of a POS-terminal device installed in the real-shop; and accomplishing a batch accounting operation for the at least one real-goods and the at least one online-goods registered on the sale registration data by use of the POS-terminal device.

It is preferable to further include the step of: displaying online-goods-related informations on a customer display of the POS-terminal device for allowing the purchaser to view the online-goods-related informations and to select the at least one online-goods from the online-goods-related informations through the POS-terminal device, and to enter purchaser's orders of the at least one real-goods and the at least one online-goods into the POS-terminal device.

In one example, the online-goods-related informations may be displayed on a printed leaflet in the real shop for allowing the purchaser to review the printed leaflet. In another example, the online-goods-related informations may be image data of the at least one online-goods. In still another example, the step of making registrations as sale registration data may include registrations as sale registration data of both image data of the at least one online-goods and an uniform resource locator of the at least one virtual-shop which deals with the at least one online-goods.

It is preferable further include the step of: printing out an order-printed sheet which presents the at least one online-goods ordered by the purchaser, wherein the order-printed sheet also serves as an ordered-goods-verification for verifying the at least one online-goods was ordered by the purchaser by use of a printer connected to the POS-terminal device.

It is also preferable that the POS-terminal device makes an access to the at least one virtual-shop which deals with the at least one online-goods for representing the purchaser in purchasing the at least one online-goods from the at least one virtual-shop.

A third aspect of the present invention is a system for realizing an electronic commerce. The system includes: at least one virtual-shop which deals with at least one online-goods; and a POS-terminal device installed in at least one real-shop which deals with at least one online-goods, and the POS-terminal device being accessible to the at least one real-shop, wherein the POS-terminal device makes registrations as sale registration data of not only at least one real-goods displayed in the real-shop and ordered by a purchaser but also at least one online-goods displayed in at least one virtual-shop and ordered by the purchaser by use of a POS-terminal device installed in the real-shop, and wherein the POS-terminal device accomplishes a batch accounting operation for the at least one real-goods and the at least one online-goods registered on the sale registration data by use of the POS-terminal device. In this case, the at least one virtual shop may be at least one net-shop on a computer-network, and the POS-terminal device is accessible through the computer-network to the at least one net-shop. The computer-network may include the Internet.

In one preferable example, the POS-terminal device may further include a customer display displaying online-goods-related informations for allowing the purchaser to view the online-goods-related informations and to select the at least one online-goods from the online-goods-related informations through the POS-terminal device, and to enter purchaser's orders of the at least one real-goods and the at least one online-goods into the POS-terminal device. In one example, the online-goods-related informations may be displayed on a printed leaflet in the real shop for allowing the purchaser to review the printed leaflet. In another example, the online-goods-related informations may be image data of the at least one online-goods. It is further preferable to include a printer which is connectable to the POS-terminal device for printing out an order-printed sheet which presents the at least one online-goods ordered by the purchaser, and wherein the order-printed sheet also serves as an ordered-good-sverification for verifying the at least one online-goods was ordered by the purchaser.

In typical example, the POS-terminal device may make an access to the at least one virtual-shop which deals with the at least one online-goods for representing the purchaser in purchasing the at least one online-goods from the at least one virtual-shop.

In one preferable example, the system may further include: an IC card assigned to the purchaser for storing at least any one information related to the purchaser; and an IC card reader connectable to the POS-terminal device for reading the informations related to the purchaser. In this case, the IC card may further store electronic verifications of the at least one real-goods and the at least one online-goods.

A fourth aspect of the present invention is a computer program to be executed for realizing an electronic commerce. The computer program includes the steps of: making registrations as sale registration data of not only at least one real-goods displayed in a real-shop and ordered by a purchaser but also at least one online-goods displayed in at least one virtual-shop and ordered by the purchaser by use of a POS-terminal device installed in the real-shop; and accomplishing a batch accounting operation for the at least one real-goods and the at least one online-goods registered on the sale registration data by use of the POS-terminal device.

In one example, it is possible to further include the step of: displaying online-goods-related informations on a customer display of the POS-terminal device for allowing the purchaser to view the online-goods-related informations and to select the at least one online-goods from the online-goods-related informations through the POS-terminal device, and to enter purchaser's orders of the at least one real-goods and the at least one online-goods into the POS-terminal device. In one example, the online-goods-related informations may be displayed on a printed leaflet in the real shop for allowing the purchaser to review the printed leaflet. In another example, the online-goods-related informations may be image data of the at least one online-goods. In still another example, the step of making registrations as sale registration data may include registrations as sale registration data of both image data of the at least one online-goods and an uniform resource locator of the at least one virtual-shop which deals with the at least one online-goods.

In one preferable example, the computer program may further include the step of: printing out an order-printed sheet which presents the at least one online-goods ordered by the purchaser, wherein the order-printed sheet also serves as an ordered-goods-verification for verifying the at least one online-goods was ordered by the purchaser by use of a printer connected to the POS-terminal device.

In one typical example, the POS-terminal device makes an access to the at least one virtual-shop which deals with the at least one online-goods for representing the purchaser in purchasing the at least one online-goods from the at least one virtual-shop.

The following embodiments are typical examples for practicing the foregoing aspects of the present invention. Although the subject matters of the present invention have been described in details, the following additional descriptions in one or more typical preferred embodiments or examples will be made with reference to the drawings for making it easy to understand the typical modes for practicing the foregoing aspects of the present invention.

### First Embodiment

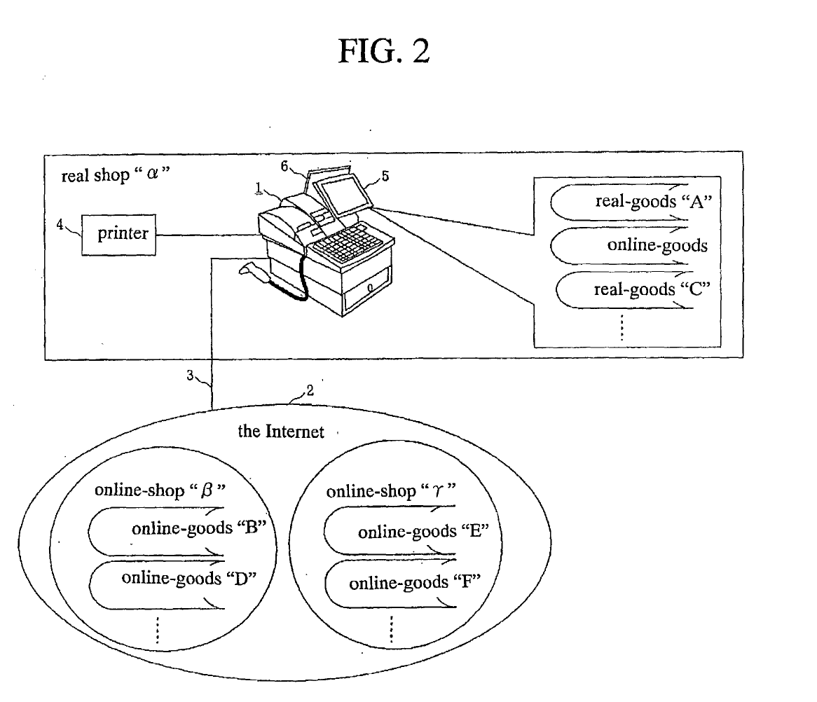

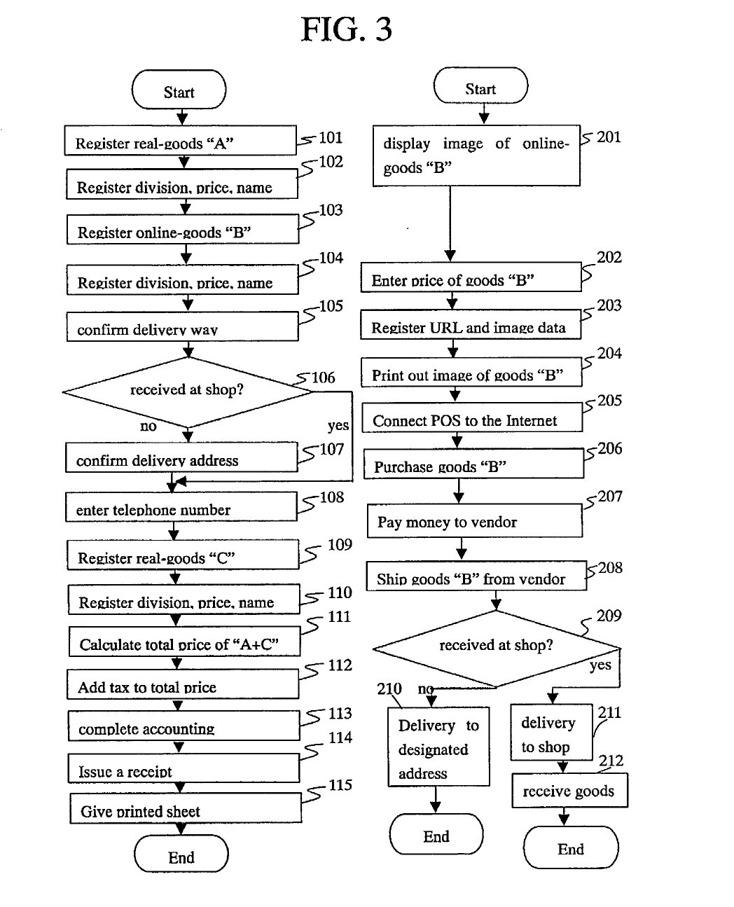

A first embodiment according to the present invention will be described in detail with reference to the drawings. FIG. 2 is a schematic view of a novel system for realizing an electronic commerce with an efficient and convenient accounting operation for purchasing one or more real goods and/or items displayed in a real shop and also purchasing one or more virtual goods and/or items displayed in a virtual shop such as online shop via a single terminal device installed in the same real shop in a first embodiment in accordance with the present invention. FIG. 3 is a flow chart of sequential operations of the electronic commerce system of FIG. 2.

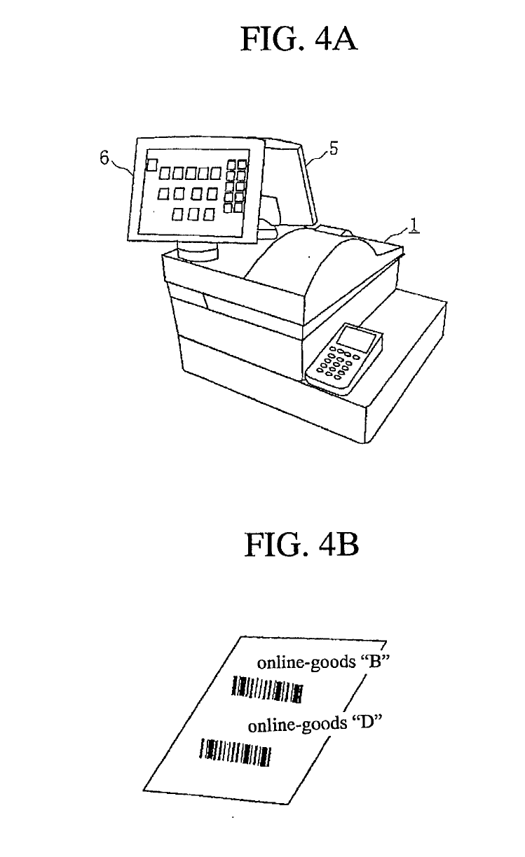

As shown in FIG. 2, the system includes a point-of-sale terminal (POS-terminal) 1 which is installed in a real shop “α”. The point-of-sale terminal (POS-terminal) 1 is connected through a communication line 3 to the Internet 2. In typical examples, the communication line 3 may include Integrated Service Digital Network (ISDN), Local Area Network (LAN), or any private line. The point-of-sale terminal (POS-terminal) 1 is connected with a printer 4. The point-of-sale terminal (POS-terminal) 1 has an operator display 5 for an operator, for example, a shop-person and also a customer display 6 for a customer, for example, a purchaser. Each of the operator display 5 and the customer display 6 has not only the display function but also an input interface function such as a touch-panel. On the Internet 2, there are plural virtual shops including online-shops “β” and “γ”. The online-shop “β”, virtually displays online-goods “B” and “D” for sales. The online-shop “γ” virtually displays online-goods “E” and “F” for sales. The real shop “α” really displays real goods “A” and “C” for sales. The purchaser may purchase any of the online-goods “B”, “D”, “E” and “F” from the point-of-sale terminal (POS-terminal) 1 in the real shop “α”, and, of course, purchase any of the real goods “A” and “C”. The real goods “A” and “C” are displayed in the real shop “α”. Informations of the online-goods “B”, “D”, “E” and “F” may be displayed on the customer display 6 of the point-of-sale terminal (POS-terminal) 1. The informations may include any informations in connection with the online-goods “B”, “D”, “E” and “F”. Alternatively or additionally, a list of the goods, respective detailed informations about each good, advertisements of the goods, and leaflets may be displayed in the real shop “α”. FIG. 4A is a schematic perspective view of a point-of-sale terminal (POS-terminal) which displays informations of the online-goods on the customer display in FIG. 2.

The purchaser may view the customer display 6 of the point-of-sale terminal (POS-terminal) 1 for direct selection of the real-goods for purchase to allow the purchaser to enter the order to purchase the real-goods through the input interface such as touch panel into the point-of-sale terminal (POS-terminal) 1.

Alternatively or additionally, the purchaser may view the above alternative or additional online-goods-related informations displayed in the real shop “α” for orally issuing, to the shop person, the order to purchase the online-goods, so that the shop person may select the online-goods over the operator display 5 and enters the order to purchase the online-goods through the operator display 5 to the point-of-sale terminal (POS-terminal) 1. Alternatively, the shop person may select the online-goods by use of a bar-code system, wherein respective bar-codes are displayed along with the respective online-goods over the list of the online-goods. FIG. 4B is a schematic view of the list of the online-goods with bar-codes. The shop person may use a bar-code reader for reading the bar-code.

With reference to FIG. 2, the left-side flow shows a first series (a) of the sequential process made through the point-of-sale terminal (POS-terminal) 1 for recording both sales of not only the real-goods but also the online-goods integrally on the point-of-sale terminal (POS-terminal) 1 in the real shop “α”, even the online-goods have been availed from the online shop. The right-side flow shows a second series (b) of the sequential process for purchasing the online-goods only. The second series (b) of the sequential process is made non-synchronously from the first series (a) of the sequential process, except for entry of the customer's informations, for example, telephone number and delivery method, for the purpose of providing the higher priority to the first series (a) of the sequential process. Further, the second series (b) of the sequential process includes printing the images of the online-goods for allowing the purchaser or customer to review and confirm the ordered online-goods.

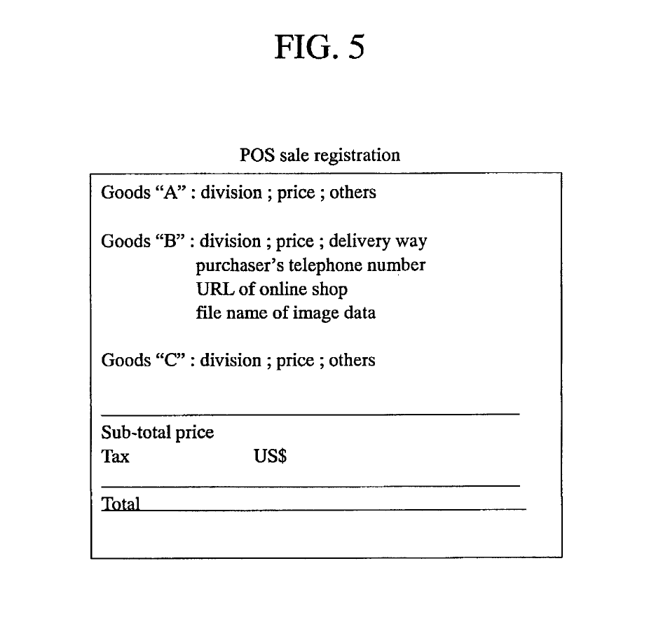

It is assumed that the purchaser purchases not only the real goods “A” and “C” but also the online goods “B” through the point-of-sale terminal (POS-terminal) 1 in the real shop “α”. The shop person in the real shop “α” serves as a POS-operator who operates the point-of-sale terminal (POS-terminal) 1. The purchaser selects the read-goods with bar-codes displayed in the real shop “α” and hand over to the POS-operator. The POS-operator makes sale-records onto the point-of-sale terminal (POS-terminal) 1 through any available input interface such as the bar-code reader or the key board. Also, the purchaser selects the online-goods, so that image data of the selected online-goods are recorded onto the point-of-sale terminal (POS-terminal) 1 and further printed out. The point-of-sale terminal (POS-terminal) 1 includes a data base which stores POS-sales registration data. FIG. 5 is a view illustrative of one typical example of data structure of the POS-sales registration data. For the real goods “A”, the POS-sales registration data include a division, a price and others. For the real goods “C”, the POS-sales registration data also include a division, a price and others. For the online-goods “B”, the POS-sales registration data also include not only a division and a price but also a delivery method, a purchaser's telephone number, and a Uniform Resource Locator (URL) of a virtual shop which deals with the online-goods “B”, and an image data file name of the online-goods “B”. The present invention provides an extremely simple structure and method for dealing with not only the real-goods but also the online-goods.

The present invention described above briefly will be described in more detail. The point-of-sale terminal (POS-terminal) 1 may have an access to an external line or an external network through the communication line 3. The communication line 3 may include Integrated Service Digital Network (ISDN), Local Area Network (LAN), or any private line. The point-of-sale terminal (POS-terminal) 1 may communicate to internet-sites of the online-shops “β” and “γ” for obtaining informations related to the online-goods “B”, “D”, “E” and “F”, so that the obtained informations may be displayed on the customer display 6, for example. Alternatively, the obtained informations may be published or printed on the list of the goods, advertisement and the leaflet.

The real goods “A” and “C” are displayed in the real shop “α”. The sale-registration for the real goods “A” and “C” may be made by use of the bar-code system. The purchaser takes the selected real-goods “A” to the checkout counter.

In Step 101, the shop person serving as the POS-operator makes a registration of the real-goods “A” onto the point-of-sale terminal (POS-terminal) 1 by scanning a bar-code accompanied to the real-goods “A” by use of a bar-code reader or by operating key boards.

In Step 102, the point-of-sale terminal (POS-terminal) 1 makes registrations of the division, price and goods name and other informations in connection with the real-goods “A” as the POS-sales registration data onto the internal data base of the point-of-sale terminal (POS-terminal) 1.

The above-described Steps 101 and 102 are identical with the conventional method for the POS-sales registration. If the purchaser wishes to purchase not only the real-goods but also any online-goods, then the purchaser views the customer display 6 of the point-of-sale terminal (POS-terminal) 1, wherein the respective informations related to the online-goods “B”, “D”, “E” and “F” including images, prices, explanations of the goods and others.

In Step 103, the purchaser selects the online-goods “B” by touching the image of the selected online-goods “B” on the touch panel of the customer display 6, so as to make a registration of the online-goods “B” onto the point-of-sale terminal (POS-terminal) 1. Upon making the registration of the online-goods “B”, the second series (b) of the sequential operations will start.

In Step 201, the point-of-sale terminal (POS-terminal) 1 recognizes that the purchaser selected the online-goods “B”, and displays, in a reduced scale, the image, the price, and the explanations of the online-goods “B” over the operator display 5 of the point-of-sale terminal (POS-terminal) 1.

In Step 202, the POS-operator or the shop person views the operator display 5 and confirms the purchaser's final intention to purchase the selected online-goods “B”. If the purchaser's final intention is to purchase the selected online-goods “B”, then the POS-operator enters the division, the price, the goods name and other informations of the online-goods “B” into the point-of-sale terminal (POS-terminal) 1 based on the informations displayed on the operator display 5.

In Step 104, upon entry of the division, the price, the goods name and other informations of the online-goods “B”, the point-of-sale terminal (POS-terminal) 1 makes a registration of the division, the price, the goods name and other informations of the online-goods “B” as the POS-sales registration data onto the data base of the point-of-sale terminal (POS-terminal) 1 in addition to the POS-sales registration data of the real-goods.

If the informations related to the online-goods “B”, “D”, “E” and “F” are displayed in the advertisement in the real shop “α”, but not displayed on the customer display 6, then the purchaser issues an oral order to purchase the online-goods “B” to the shop person or the POS-operator. In this case, the images, the prices and the explanations of the goods of the online-goods “B”, “D”, “E” and “F” are, however, displayed on the operator display 5 of the point-of-sale terminal (POS-terminal) 1. In accordance with the purchaser's oral order to purchase the online-goods “B”, the POS-operator touches the image of the online-goods “B” to select the online-goods “B”, before the POS-operator enters the division, the price, the goods name and the explanations of the online-goods “B” into the point-of-sale terminal (POS-terminal) 1. Alternatively, in accordance with the purchaser's oral order to purchase the online-goods “B”, the POS-operator makes a registration of the division, the price, and the goods name of the online-goods “B” into the point-of-sale terminal (POS-terminal) 1 by scanning with use of the bar-code reader.

In Step 105, the POS-operator receives a purchaser's oral instruction of whether direct receipt of the online-goods “B” in the real shop “α” or how to delivery the online-goods “B”, so that the POS-operator enters the purchaser's delivery instruction into the point-of-sale terminal POS-terminal) 1. The point-of-sale terminal (POS-terminal) 1 makes a registration of the purchaser's delivery instruction in addition to the POS-sales registration data in connection with the online-goods “B”.

In Step 106, if the purchaser's oral instruction is to delivery the online-goods “3”, then in Step 107, the POS-operator asks the purchaser to designate a delivery address.

In Step 108, the POS-operator enters a telephone number of the purchaser into the point-of-sale terminal (POS-terminal) 1. The point-of-sale terminal (POS-terminal) 1 makes a registration of the purchaser's telephone number in addition to the POS-sales registration data in connection with the online-goods “B”.

In Step 203, the point-of-sale terminal (POS-terminal) 1 makes a registration of the Uniform Resource Locator (URL) of the online-shop “β” in addition to the POS-sales registration data in connection with the online-goods “B”. The online-shop “β” deals with the online-goods “B”. The point-of-sale terminal (POS-terminal) 1 also stores the image data of the online-goods “B” into the data base of the point-of-sale terminal (POS-terminal) 1. The point-of-sale terminal (POS-terminal) 1 also makes a registration of the file name of the stored image data in addition to the POS-sales registration data in connection with the online-goods “B”.

In Step 204, the point-of-sale terminal (POS-terminal) 1 makes the printer 4 to print out the image of the online-goods “B”.

In Step 109, if the purchaser further purchases the real goods “C” displayed in the real shop “α”, then the POS-operator makes a registration of the real-goods “C” onto the point-of-sale terminal (POS-terminal) 1 by scanning a bar-code accompanied to the real-goods “C” by use of a bar-code reader or by operating key boards.

In Step 110, the point-of-sale terminal (POS-terminal) 1 makes registrations of the division, price and goods name and other informations in connection with the real-goods “C” as the POS-sales registration data onto the internal data base of the point-of-sale terminal (POS-terminal) 1.

In Step 111, after the sale registrations of all the real-goods and the online-goods ordered by the purchaser have been completed, then the point-of-sale terminal (POS-terminal) 1 calculates the total price of the respective prices of the real-goods “A” and “C” and the online-goods “B”.

In Step 112, the point-of-sale terminal (POS-terminal) 1 further calculates the sum of a consumption tax and the above-calculated total price, and then displays the sum on the operator display 5. The above-described processes completed the POS-sales registration data.

In Step 113, the POS-operator receives, by hand from the purchaser, a money which corresponds to the sum displayed on the operator display 5.

In Step 114, the point-of-sale terminal (POS-terminal) 1 prints out a receipt and the POS-operator gives the purchaser the receipt.

In Step 115, the POS-operator gives the purchaser the printed sheet as a written commitment to give the purchaser the ordered online-goods “B”, wherein the printed sheet was printed out from the printer in Step 204. If the purchaser wishes to receive the ordered online-goods “B”, then the purchaser may present the printed sheet and receives by hand the purchased online-goods “B” in the real shop “α”.

Since the real shop “α” received, from the purchaser, the money for the ordered online-goods “B”, then the real shop “α” represents the purchaser in purchasing the ordered online-goods “B”.

In Step 205, after receipt of the money for the ordered online-goods “B” from the purchaser, the point-of-sale terminal (POS-terminal) 1 makes an access to the online-shop “β” on the Internet 2 based on the registered URL on the POS-sales registration data.

In Step 206, the POS-operator makes a purchasing procedure for purchasing the ordered online-goods “B” from the online-shop “β” in the name of the real shop “α” representing the purchaser. The POS-operator further designates a delivery address and a delivery way of the ordered online-goods “B” in accordance with the purchaser's-designated delivery address and way.

In Step 207, a vendor of the online-shop “β” confirms the payment for the online-goods “B”.

In Step 208, the vendor of the online-shop “β” ships the online-goods “B” to the designated delivery address by the designated delivery way.

In Step 209, if the designated delivery address is of a purchaser's home, then in Step 210, the vendor delivers the online-goods “B” to the purchaser's home. In Step 209, if the designated delivery address is of the real shop “α”, then in Step 211, the vendor delivers the online-goods “B” to the real shop “α” before the shop person of the real shop “α” makes a contact to the purchaser to inform the purchaser that the online-goods “B” has arrived at the real shop “α”.

In Step 212, the purchaser indicates the shop person of the real shop “α” with the printed sheet as the written commitment to give the purchaser the ordered online-goods “B”, and the purchaser receives the online-goods “B” at the real shop “α”. If the real shop “α” could not purchase the ordered online-goods “B”, then the shop person of the real shop “α” makes a contact to the purchaser to inform the purchaser that the online-goods “B” could not be purchased, and the real shop “α” returns the money for the online-goods “B”.

The above-described point-of-sale terminal (POS-terminal) 1 may be realized by a computer. In typical example, this computer may include a CPU, a memory, a key board, the operator display 5, the customer display 6, the bar-code reader, and an interface to an external memory. The CPU may execute the above-described sequential processes in accordance with a computer program or commands entered from the key board. The CPU executes the read and write operations to the external memory device.

The program to be executed for realizing the electronic commerce may be stored in any available storage medium such as flexible disks, CD-ROM, DVD-ROM, and memory cards. The storage medium storing the program is inserted into the external memory, so that the program is read out and then transferred into the computer which serves as the point-of-sale terminal (POS-terminal) 1, whereby the program is executed by the CPU for realizing the above-described electronic commerce.

The novel method and system for allowing the purchaser to purchase, in a real shop, not only at least a real goods displayed in the real shop but also at least a virtual goods displayed in at least a virtual shop have been provided. Both sale registrations of the real goods and the virtual goods on the common sale registration data are made, before a batch account operation is made of not only the real goods but also the virtual goods which have been registered on the common sale registration data, so that the purchaser may purchase, in the real shop, not the real goods but also the virtual goods at substantially the same operations as necessary for purchasing the real goods only. Only one accounting operation is necessary for purchasing both the real goods and virtual goods.

In one preferable example, the sale registrations of the real goods and the virtual goods may be made with the common data structure. This allows introduction of the above-described new POS-system into the real shop without any large change in application software or any additional hardware. Namely, the above-described novel method for realizing the new electronic commerce may be realized without any additional hardware and software. This means that no further large expense to the conventional POS-system is necessary for realizing the new electronic commerce. The degree of convenience for the customer or purchaser is increased. The real shop which allow the customer or purchaser to purchase not only the real goods but also the virtual goods by the single batch accounting operation would be attractive to the customer or purchaser.

The images of the virtual goods which has been registered on the sale registration data are printed on a paper which is a written verification sheet or a written commitment sheet for verifying the purchaser's ordered virtual goods to prevent any possible mistake in buy and sale operations.

The image data of the purchaser's ordered virtual goods and the URL of the virtual shop which deals with the purchaser's ordered virtual goods are registered onto the sale registration data, so that the management in sale of the virtual goods dealt with by the virtual shop may be made by the above-described POS-system installed in the real shop independent from any system of the virtual shop.

### Second Embodiment

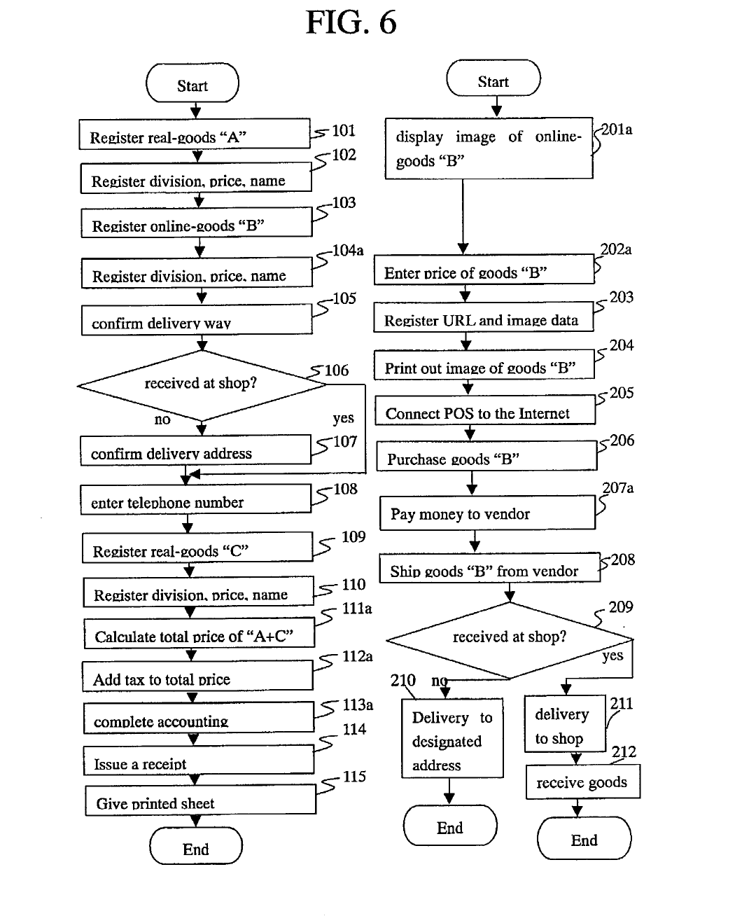

A second embodiment according to the present invention will be described in detail with reference to the drawings. This second embodiment is different in parts of the sequential processes for realizing the electronic commerce by use of the above-described system including the point-of-sale terminal (POS-terminal) 1. The following descriptions will focus on sequential operations of the electronic commerce system. FIG. 6 is a flow chart of sequential operations of the electronic commerce system in the second embodiment in accordance with the present invention.

In this second embodiment, any margin income to the real shop “α” is allowed, while the price of the virtual goods is increased by the margin income. Namely, the online-shops “β” and “γ” set the respective prices of the online-goods in consideration of the respective margin incomes into the real shop “α”.

In Step 101, the shop person serving as the POS-operator makes a registration of the real-goods “A” onto the point-of-sale terminal (POS-terminal) 1 by scanning a bar-code accompanied to the real-goods “A” by use of a bar-code reader or by operating key boards.

In Step 102, the point-of-sale terminal (POS-terminal) 1 makes registrations of the division, price and goods name and other informations in connection with the real-goods “A” as the POS-sales registration data onto the internal data base of the point-of-sale terminal (POS-terminal) 1.

The above-described Steps 101 and 102 are identical with the conventional method for the POS-sales registration. If the purchaser wishes to purchase not only the real-goods but also any online-goods, then the purchaser views the customer display 6 of the point-of-sale terminal (POS-terminal) 1, wherein the respective informations related to the online-goods “B”, “D”, “E” and “F” including images, prices, explanations of the goods and others.

In Step 103, the purchaser selects the online-goods “B” by touching the image of the selected online-goods “B” on the touch panel of the customer display 6, so as to make a registration of the online-goods “B” onto the point-of-sale terminal (POS-terminal) 1. Upon making the registration of the online-goods “B”, the second series (b) of the sequential operations will start.

In Step 201a, the point-of-sale terminal (POS-terminal) 1 recognizes that the purchaser selected the online-goods “B”, and displays, in a reduced scale, the image, the price, and the explanations of the online-goods “B” over the operator display 5 of the point-of-sale terminal (POS-terminal) 1, wherein the price includes the margin income into the real shop “α”.

In Step 202a, the POS-operator or the shop person views the operator display 5 and confirms the purchaser's final intention to purchase the selected online-goods “B”. If the purchaser's final intention is to purchase the selected online-goods “B”, then the POS-operator enters the division, the price, the goods name and other informations of the online-goods “B” into the point-of-sale terminal (POS-terminal) 1 based on the informations displayed on the operator display 5, wherein the price includes the margin income into the real shop “α”.

In Step 104a, upon entry of the division, the price, the goods name and other informations of the online-goods “B”, the point-of-sale terminal (POS-terminal) 1 makes a registration of the division, the price, the goods name and other informations of the online-goods “B” as the POS-sales registration data onto the data base of the point-of-sale terminal (POS-terminal) 1 in addition to the POS-sales registration data of the real-goods, wherein the price includes the margin income into the real shop “α”.

If the informations related to the online-goods “B”, “D”, “E” and “F” are displayed in the advertisement in the real shop “α”, but not displayed on the customer display 6, then the purchaser issues an oral order to purchase the online-goods “B” to the shop person or the POS-operator. In this case, the images, the prices and the explanations of the goods of the online-goods “B”, “D”, “E” and “F” are, however, displayed on the operator display 5 of the point-of-sale terminal (POS-terminal) 1. In accordance with the purchaser's oral order to purchase the online-goods “B”, the POS-operator touches the image of the online-goods “B” to select the online-goods “B”, before the POS-operator enters the division, the price, the goods name and the explanations of the online-goods “B” into the point-of-sale terminal (POS-terminal) 1, wherein the price includes the margin income into the real shop “α”. Alternatively, in accordance with the purchaser's oral order to purchase the online-goods “B”, the POS-operator makes a registration of the division, the price, and the goods name of the online-goods “B” into the point-of-sale terminal (POS-terminal) 1 by scanning with use of the bar-code reader, wherein the price includes the margin income into the real shop “α”.

In Step 105, the POS-operator receives a purchaser's oral instruction of whether direct receipt of the online-goods “B” in the real shop “α” or how to delivery the online-goods “B”, so that the POS-operator enters the purchaser's delivery instruction into the point-of-sale terminal (POS-terminal) 1. The point-of-sale terminal (POS-terminal) 1 makes a registration of the purchaser's delivery instruction in addition to the POS-sales registration data in connection with the online-goods “B”.

In Step 106, if the purchaser's oral instruction is to delivery the online-goods “B”, then in Step 107, the POS-operator asks the purchaser to designate a delivery address.

In Step 108, the POS-operator enters a telephone number of the purchaser into the point-of-sale terminal (POS-terminal) 1. The point-of-sale terminal (POS-terminal) 1 makes a registration of the purchaser's telephone number in addition to the POS-sales registration data in connection with the online-goods “B”.

In Step 203, the point-of-sale terminal (POS-terminal) 1 makes a registration of the Uniform Resource Locator (URL) of the online-shop “β” in addition to the POS-sales registration data in connection with the online-goods “B”. The online-shop “β” deals with the online-goods “B”. The point-of-sale terminal (POS-terminal) 1 also stores the image data of the online-goods “B” into the data base of the point-of-sale terminal (POS-terminal) 1. The point-of-sale terminal (POS-terminal) 1 also makes a registration of the file name of the stored image data in addition to the POS-sales registration data in connection with the online-goods “B”.

In Step 204, the point-of-sale terminal (POS-terminal) 1 makes the printer 4 to print out the image of the online-goods “B”.

In Step 109, if the purchaser further purchases the real goods “C” displayed in the real shop “α”, then the POS-operator makes a registration of the real-goods “C” onto the point-of-sale terminal (POS-terminal) 1 by scanning a bar-code accompanied to the real-goods “C” by use of a bar-code reader or by operating key boards.

In Step 110, the point-of-sale terminal (POS-terminal) 1 makes registrations of the division, price and goods name and other informations in connection with the real-goods “C” as the POS-sales registration data onto the internal data base of the point-of-sale terminal (POS-terminal) 1.

In Step 111a, after the sale registrations of all the real-goods and the online-goods ordered by the purchaser have been completed, then the point-of-sale terminal (POS-terminal) 1 calculates the total price of the respective prices of the real-goods “A” and “C” and the online-goods “B”, wherein the price of the online-goods “B” includes the margin income into the real shop “α”.

In Step 112a, the point-of-sale terminal (POS-terminal) 1 further calculates the sum of a consumption tax and the above-calculated total price, and then displays the sum on the operator display 5. The above-described processes completed the POS-sales registration data.

In Step 113a, the POS-operator receives, by hand from the purchaser, a money which corresponds to the sum displayed on the operator display 5.

In Step 114, the point-of-sale terminal (POS-terminal) 1 prints out a receipt and the POS-operator gives the purchaser the receipt.

In Step 115, the POS-operator gives the purchaser the printed sheet as a written commitment to give the purchaser the ordered online-goods “B”, wherein the printed sheet was printed out from the printer in Step 204. If the purchaser wishes to receive the ordered online-goods “B”, then the purchaser may present the printed sheet and receives by hand the purchased online-goods “B” in the real shop “α”.

Since the real shop “α” received, from the purchaser, the money for the ordered online-goods “B”, then the real shop “α” represents the purchaser in purchasing the ordered online-goods “B”.

In Step 205, after receipt of the money for the ordered online-goods “B” from the purchaser, the point-of-sale terminal (POS-terminal) 1 makes an access to the online-shop “β” on the Internet 2 based on the registered URL on the POS-sales registration data.

In Step 206, the POS-operator makes a purchasing procedure for purchasing the ordered online-goods “B” from the online-shop “β” in the name of the real shop “α” representing the purchaser. The POS-operator further designates a delivery address and a delivery way of the ordered online-goods “B” in accordance with the purchaser's-designated delivery address and way.

In Step 207a, a vendor of the online-shop “β” confirms the payment for the online-goods “B”, wherein the amount of payment corresponds to the subtraction of the price of the online-goods “B” by the margin income.

In Step 208, the vendor of the online-shop “β” ships the online-goods “B” to the designated delivery address by the designated delivery way.

In Step 209, if the designated delivery address is of a purchaser's home, then in Step 210, the vendor delivers the online-goods “B” to the purchaser's home. In Step 209, if the designated delivery address is of the real shop “α”, then in Step 211, the vendor delivers the online-goods “B” to the real shop “α” before the shop person of the real shop “α” makes a contact to the purchaser to inform the purchaser that the online-goods “B” has arrived at the real shop “α”.

In Step 212, the purchaser indicates the shop person of the real shop “α” with the printed sheet as the written commitment to give the purchaser the ordered online-goods “B”, and the purchaser receives the online-goods “B” at the real shop “α”. If the real shop “α” could not purchase the ordered online-goods “B”, then the shop person of the real shop “α” makes a contact to the purchaser to inform the purchaser that the online-goods “B” could not be purchased, and the real shop “α” returns the money for the online-goods “B”.

The above margin may be effective to promote the online sales of the online-goods by advertisement or introduction of the online-shops “β” and “γ” in the real shop “α”.

The novel method and system for allowing the purchaser to purchase, in a real shop, not only at least a real goods displayed in the real shop but also at least a virtual goods displayed in at least a virtual shop have been provided. Both sale registrations of the real goods and the virtual goods on the common sale registration data are made, before a batch account operation is made of not only the real goods but also the virtual goods which have been registered on the common sale registration data, so that the purchaser may purchase, in the real shop, not the real goods but also the virtual goods at substantially the same operations as necessary for purchasing the real goods only. Only one accounting operation is necessary for purchasing both the real goods and virtual goods.

In one preferable example, the sale registrations of the real goods and the virtual goods may be made with the common data structure. This allows introduction of the above-described new POS-system into the real shop without any large change in application software or any additional hardware. Namely, the above-described novel method for realizing the new electronic commerce may be realized without any additional hardware and software. This means that no further large expense to the conventional POS-system is necessary for realizing the new electronic commerce. The degree of convenience for the customer or purchaser is increased. The real shop which allow the customer or purchaser to purchase not only the real goods but also the virtual goods by the single batch accounting operation would be attractive to the customer or purchaser.

The images of the virtual goods which has been registered on the sale registration data are printed on a paper which is a written verification sheet or a written commitment sheet for verifying the purchaser's ordered virtual goods to prevent any possible mistake in buy and sale operations.

The image data of the purchaser's ordered virtual goods and the URL of the virtual shop which deals with the purchaser's ordered virtual goods are registered onto the sale registration data, so that the management in sale of the virtual goods dealt with by the virtual shop may be made by the above-described POS-system installed in the real shop independent from any system of the virtual shop.

### Third Embodiment

A third embodiment according to the present invention will be described in detail with reference to the drawings. This third embodiment is different in additional use of an IC card reader which is electrically connected to the point-of-sale terminal (POS-terminal) 1 which is the same as in the above-described first and second embodiments, wherein the point-of-sale terminal (POS-terminal) 1 is installed in the real shop “α”. Respective verifications of purchasing the real and goods and the online goods may be recorded onto each of the purchasers. The IC card may previously store the purchaser's related informations such as address and telephone number. This makes it unnecessary to make a registration of the delivery address and the telephone number in the sale registration process. The use of this IC card may be effective or efficient in identification of the purchaser. Any additional information about utilization frequency may also be stored into the IC card. Namely, the IC card may be used for buy and sale management.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

The entire contents of priority document 2001-299754, filed on Sep. 28, 2001, is incorporated in its entirety herein by reference.

What is claimed is:

1. A method of realizing an electronic commerce, said method including the steps of:
making registrations as sale registration data of not only at least one real-goods displayed in a real-shop and ordered by a purchaser but also at least one online-goods displayed in at least one virtual-shop and ordered by said purchaser; and
accomplishing a batch accounting operation for said at least one real-goods and said at least one online-goods registered on said sale registration data.

2. The method as claimed in claim 1, further including the step of:
displaying online-goods-related informations for allowing said purchaser to view said online-goods-related informations and to select said at least one online-goods from said online-goods-related informations.

3. The method as claimed in claim 2, wherein said online-goods-related informations are displayed on a customer display device in said real shop for allowing said purchaser to review said customer display device.

4. The method as claimed in claim 2, wherein said online-goods-related informations are displayed on a printed paper in said real shop for allowing said purchaser to review said printed paper.

5. The method as claimed in claim 2, wherein said online-goods-related informations are displayed on a printed leaflet in said real shop for allowing said purchaser to review said printed leaflet.

6. The method as claimed in claim 2, wherein said online-goods-related informations are image data of said at least one online-goods.

7. The method as claimed in claim 1, wherein said step of making registrations as sale registration data includes registrations as sale registration data of both image data of said at least one online-goods and an uniform resource locator of said at least one virtual-shop which deals with said at least one online-goods.

8. The method as claimed in claim 1, further including the step of:
printing out an order-printed sheet which presents said at least one online-goods ordered by said purchaser, wherein said order-printed sheet also serves as an ordered-goods-verification for verifying said at least one online-goods was ordered by said purchaser.

9. The method as claimed in claim 1, wherein said step of making registrations as sale registration data and said step of accomplishing said batch accounting operation are realized by use of a terminal device installed in a real shop.

10. The method as claimed in claim 9, wherein said terminal device makes an access to said at least one virtual-shop which deals with said at least one online-goods for representing said purchaser in purchasing said at least one online-goods from said at least one virtual-shop.

11. A method of realizing an electronic commerce, said method including the steps of:
making registrations as sale registration data of not only at least one real-goods displayed in a real-shop and ordered by a purchaser but also at least one online-goods displayed in at least one virtual-shop and ordered by said purchaser by use of a POS-terminal device installed in said real-shop; and
accomplishing a batch accounting operation for said at least one real-goods and said at least one online-goods registered on said sale registration data by use of said POS-terminal device.

12. The method as claimed in claim 11, further including the step of:
displaying online-goods-related informations on a customer display of said POS-terminal device for allowing said purchaser to view said online-goods-related informations and to select said at least one online-goods from said online-goods-related informations through said POS-terminal device, and to enter purchaser's orders of said at least one real-goods and said at least one online-goods into said POS-terminal device.

13. The method as claimed in claim 12, wherein said online-goods-related informations are displayed on a printed leaflet in said real shop for allowing said purchaser to review said printed leaflet.

14. The method as claimed in claim 12, wherein said online-goods-related informations are image data of said at least one online-goods.

15. The method as claimed in claim 11, wherein said step of making registrations as sale registration data includes registrations as sale registration data of both image data of said at least one online-goods and an uniform resource locator of said at least one virtual-shop which deals with said at least one online-goods.

16. The method as claimed in claim 11, further including the step of:
printing out an order-printed sheet which presents said at least one online-goods ordered by said purchaser, wherein said order-printed sheet also serves as an ordered-goods-verification for verifying said at least one online-goods was ordered by said purchaser by use of a printer connected to said POS-terminal device.

17. The method as claimed in claim 11, wherein said POS-terminal device makes an access to said at least one virtual-shop which deals with said at least one online-goods for representing said purchaser in purchasing said at least one online-goods from said at least one virtual-shop.

18. A system for realizing an electronic commerce, said system including:
at least one virtual-shop which deals with at least one online-goods; and
a POS-terminal device installed in at least one real-shop which deals with at least one online-goods, and said POS-terminal device being accessible to said at least one real-shop,
wherein said POS-terminal device makes registrations as sale registration data of not only at least one real-goods displayed in said real-shop and ordered by a purchaser but also at least one online-goods displayed in at least one virtual-shop and ordered by said purchaser by use of a POS-terminal device installed in said real-shop, and
wherein said POS-terminal device accomplishes a batch accounting operation for said at least one real-goods and said at least one online-goods registered on said sale registration data by use of said POS-terminal device.

19. The system as claimed in claim 18, wherein said at least one virtual shop is at least one net-shop on a computer-network, and said POS-terminal device is accessible through said computer-network to said at least one net-shop.

20. The system as claimed in claim 18, wherein said computer-network includes the Internet.

21. The system as claimed in claim 18, wherein said POS-terminal device further includes a customer display displaying online-goods-related informations for allowing said purchaser to view said online-goods-related informations and to select said at least one online-goods from said online-goods-related informations through said POS-terminal device, and to enter purchaser's orders of said at least one real-goods and said at least one online-goods into said POS-terminal device.

22. The system as claimed in claim 21, wherein said online-goods-related informations are displayed on a printed leaflet in said real shop for allowing said purchaser to review said printed leaflet.

23. The system as claimed in claim 21, wherein said online-goods-related informations are image data of said at least one online-goods.

24. The system as claimed in claim 18, further including a printer which is connectable to said POS-terminal device for printing out an order-printed sheet which presents said at least one online-goods ordered by said purchaser, and wherein said order-printed sheet also serves as an ordered-goods-verification for verifying said at least one online-goods was ordered by said purchaser.

25. The system as claimed in claim 18, wherein said POS-terminal device makes an access to said at least one virtual-shop which deals with said at least one online-goods for representing said purchaser in purchasing said at least one online-goods from said at least one virtual-shop.

26. The system as claimed in claim 18, further including:
an IC card assigned to said purchaser for storing at least any one information related to said purchaser; and
an IC card reader connectable to said POS-terminal device for reading said informations related to said purchaser.

27. The system as claimed in claim 26, wherein said IC card further stores electronic verifications of said at least one real-goods and said at least one online-goods.

28. A computer program to be executed for realizing an electronic commerce, said computer program including the steps of:
making registrations as sale registration data of not only at least one real-goods displayed in a real-shop and ordered by a purchaser but also at least one online-goods displayed in at least one virtual-shop and ordered by said purchaser by use of a POS-terminal device installed in said real-shop; and
accomplishing a batch accounting operation for said at least one real-goods and said at least one online-goods registered on said sale registration data by use of said POS-terminal device.

29. The computer program as claimed in claim 28, further including the step of:
displaying online-goods-related informations on a customer display of said POS-terminal device for allowing said purchaser to view said online-goods-related informations and to select said at least one online-goods from said online-goods-related informations through said POS-terminal device, and to enter purchaser's orders of said at least one real-goods and said at least one online-goods into said POS-terminal device.

30. The computer program as claimed in claim 29, wherein said online-goods-related informations are displayed on a printed leaflet in said real shop for allowing said purchaser to review said printed leaflet.

31. The computer program as claimed in claim 29, wherein said online-goods-related informations are image data of said at least one online-goods.

32. The computer program as claimed in claim 28, wherein said step of making registrations as sale registration data includes registrations as sale registration data of both image data of said at least one online-goods and an uniform resource locator of said at least one virtual-shop which deals with said at least one online-goods.

33. The computer program as claimed in claim 28, further including the step of:
printing out an order-printed sheet which presents said at least one online-goods ordered by said purchaser, wherein said order-printed sheet also serves as an ordered-goods-verification for verifying said at least one online-goods was ordered by said purchaser by use of a printer connected to said POS-terminal device.

34. The computer program as claimed in claim 28, wherein said POS-terminal device makes an access to said at least one virtual-shop which deals with said at least one online-goods for representing said purchaser in purchasing said at least one online-goods from said at least one virtual-shop.
